(19) United States
(12) Patent Application Publication
(10) Pub. No.: US 2011/0258492 A1
(43) Pub. Date: Oct. 20, 2011

(54) DEVICE FOR TESTING SERIAL INTERFACE

(75) Inventors: CHAO-TSUNG FAN, Tu-Cheng (TW); LI-JEN HUANG, Tu-Cheng (TW)

(73) Assignee: HON HAI PRECISION INDUSTRY CO., LTD., Tu-Cheng (TW)

(21) Appl. No.: 12/815,330

(22) Filed: Jun. 14, 2010

(30) Foreign Application Priority Data
Apr. 14, 2010 (TW) 99111686

(51) Int. Cl. G06F 11/26

(52) U.S. Cl. 714/43; 714/E11.159

(57) ABSTRACT

A device for testing a serial interface of a circuit board. The device includes a testing serial interface, a memory, a processor. The testing serial interface is coupled to the serial interface of the circuit board. The processor is electrically connected between the memory and the at least one testing serial interface. The processor is configured for receiving first serial data from the circuit board via the testing serial interface, converting the first serial data to parallel data, and writing the parallel data into the memory, and also configured for reading the parallel data from the memory, converting the parallel data to second serial data and transmits the second serial data to the circuit board via the testing serial interface.

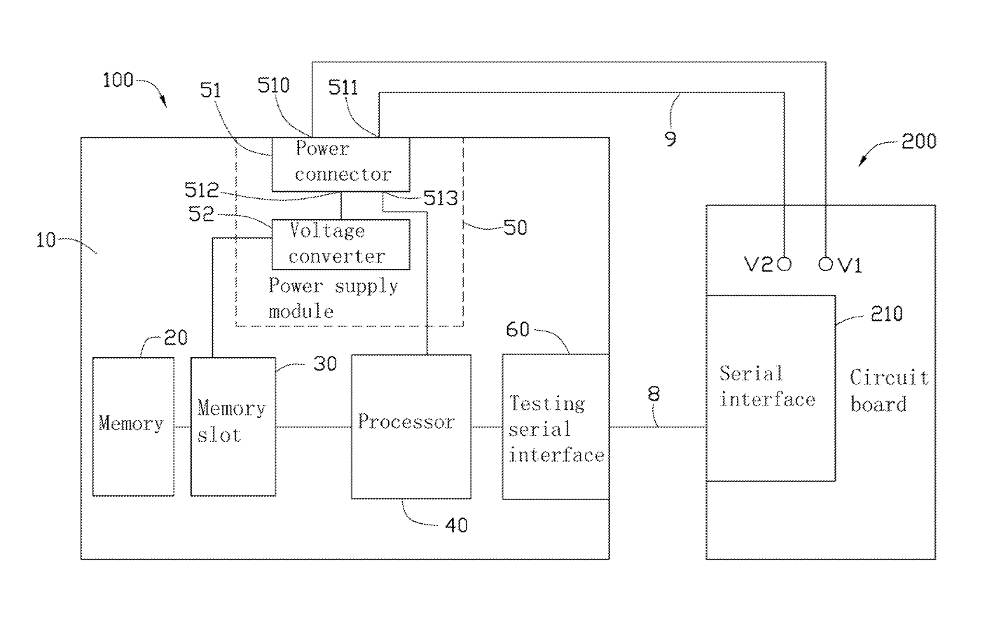

### BACKGROUND

1. Technical Field

The present disclosure relates to testing devices and, particularly, to a device for testing serial interfaces.

2. Description of Related Art

A conventional method for testing serial interfaces of motherboards includes connecting a serial hard disk to the interface. However, this conventional method may require many serial hard disks to connect to multiple serial interfaces of motherboards and therefore is costly and inconvenient.

What is needed, therefore, is a device for testing serial interfaces to overcome the above-described problem.

### BRIEF DESCRIPTION OF THE DRAWINGS

Many aspects of the device for testing serial interfaces can be better understood with reference to the following drawings. The components in the drawings are not necessarily drawn to scale, the emphasis instead being placed upon clearly illustrating the principles of the device for testing serial interfaces.

The drawing is a block diagram of a device for testing serial interfaces according to an exemplary embodiment.

### DETAILED DESCRIPTION

Embodiments of the present disclosure will now be described in detail below, with reference to the accompanying drawing.

Referring to the drawing, a block diagram of a device 100 for testing serial interfaces according to an exemplary embodiment, is shown. The device 100 is used in place of a serial hard disk to test a serial interface of a circuit board 200. In the present embodiment, the circuit board 200 is a motherboard used in a computer. The circuit board 200 includes a serial interface 210 to be tested, a first power supply V1 and a second power supply V2. A testing program is stored in the basic input/output system (BIOS) of the circuit board 200. The serial interface 210 is a serial advanced technology attachment interface or a serial attached small computer system interface. The first power supply V1 supplies a voltage of 5V and the second power supply V2 supplies a voltage of 3.3V.

The device 100 includes a holder 10, a memory 20, a memory slot 30, a processor 40, a power supply module 50 and a testing serial interface 60. The holder 10 is a circuit board. The memory 20 is plugged into the memory slot 30. The memory slot 30, the processor 40, the power supply module 50 and the testing serial interface 60 are mounted on the holder 10. The testing serial interface 60 corresponds to the type of the serial interface 210. The memory slot 30 is electrically connected to the processor 40. The processor 40 is electrically connected to the testing serial interface 60. The power supply module 50 is electrically connected to the memory slot 30 and the processor 40 to supply appropriate amounts of power to the processor 40 and the memory 20.

The storage capacity of the memory 20 is equal to the storage of a hard disk. In the present embodiment, the memory 20 is a double-data-rate synchronous dynamic random access memory generation 2 (DDR2). The memory 20 can also be a DDR1 or a DDR3. In an alternative embodiment, the memory 20 is directly mounted on the holder 10 and the memory slot 30 is omitted, and the memory 20 is directly electrically connected to the processor 40 and the power supply module 50 by means of printed circuits.

The testing serial interface 60 is connected to the serial interface 210 by a data cable 8. The processor 40 is configured for receiving serial data from the circuit board 200 via the testing serial interface 60 and the serial interface 210, and converting the serial data to parallel data, and writing the parallel data into the memory 20. The processor 40 is also configured for reading the parallel data from the memory 20, and converting the parallel data to serial data, and transmitting the serial data to the circuit board 200 via the testing serial interface 60 and the serial interface 210. In the present embodiment, the processor 40 could be a Spartan XC3S1400A chip manufactured by Xilinx Inc. When the memory 20 is DDR3, the processor 40 could be a Spartan XC6SLX150T chip manufactured by Xilinx Inc. In an alternative embodiment, when the circuit board 200 includes a number of serial interfaces 210 needing to be tested, the device 100 is equipped with a number of testing serial interfaces 60 corresponding to the serial interfaces 210 of the circuit 200.

The power supply module 50 can be an embedded power supply or a circuit electrically connected to an external power supply. In the present embodiment, the power supply module 50 is a circuit electrically connected to the first power supply V1 and the second power supply V2. The power supply module 50 includes a power connector 51 and a voltage converter 52. The power connector 51 includes a first input end 510, a second input end 511, a first output end 512, and a second output end 513. The first input end 510 and the second input end 511 are electrically connected to the first power supply V1 and the second power supply V2 correspondingly by a lead 9. The first output end 512 supplies a voltage same as that provided by the first power supply V1. The second output end 513 supplies a voltage same as that provided by the second power supply V2. The first output end 512 is electrically connected to the memory slot 30 through the voltage converter 52. The second output end 513 is directly electrically connected to the processor 40 for applying the working voltage of the processor 40 same as that provided by the second power supply V2. In the present embodiment, the working voltage of the memory 20 is 1.8V. The voltage converter 52 is provided for receiving 5V voltage from the second output end 523 and supplying 1.8V voltage to the memory 20. When the memory 20 is a DDR3, the voltage converter 52 is configured for supplying 1.5V voltage to the memory 20.

In the testing process, the testing program stored in the circuit board 200 is run, and a group of serial data (hereinafter “the original serial data”) is sent to the processor 40 via the serial interface 210 and the testing serial interface 60. The processor 40 converts the original serial data to parallel data before the parallel data is written into the memory 20. When the circuit board 200 reads the written parallel data from the memory 20, the parallel data in memory 20 is converted into serial data by the processor 40 before being received by the circuit board 200. The circuit board 200 compares the received serial data with the original serial data to determine the performance of the serial interface 210.

While certain embodiments have been described and exemplified above, various other embodiments will be apparent to those skilled in the art from the foregoing disclosure. The present disclosure is not limited to the particular embodiments described and exemplified, and the embodiments are capable of considerable variation and modification without departure from the scope of the appended claims.

What is claimed is:

1. A device for testing a serial interface of a circuit board, comprising:
a testing serial interface coupled to the serial interface of the circuit board;
a memory;
a processor electrically connected between the memory and the testing serial interface, the processor configured for receiving first serial data from the circuit board via the testing serial interface, converting the first serial data to parallel data, and writing the parallel data into the memory, and also configured for reading the parallel data from the memory, converting the parallel data to second serial data and transmitting the second serial data to the circuit board via the testing serial interface.

2. The device as claimed in claim 1, wherein the memory is a double-data-rate synchronous dynamic random access memory.

3. The device as claimed in claim 1, further comprising a power supply module electrically connected to the memory and the processor, and supplying power to the memory and the processor.

4. The device as claimed in claim 3, wherein the power supply module is an embedded power supply, or a circuit electrically connected to an outer power supply via a connector.

5. The device as claimed in claim 4, wherein the outer power supply is supplied by the circuit board.

6. The device as claimed in claim 4, wherein the power supply module comprises a voltage converter configure for supplying a working voltage for the memory and the processor.

7. The device as claimed in claim 6, wherein the voltage converter is electrically connected between the connector and the memory, and configured for converting an appropriate voltage for the memory.

8. The device for testing interface as claimed in claim 1, further comprising a memory slot configured for receiving the memory.

9. The device as claimed in claim 1, further comprising a holder, wherein the memory, the processor, and the testing serial interface are mounted on the holder.

10. The device as claimed in claim 8, further comprising a holder, wherein the memory slot, the processor, and the testing serial interface are mounted on the holder.

11. The device as claimed in claim 1, wherein the testing serial interface is a serial advanced technology attachment interface, or a serial attached small computer system interface.
